(19) United States
(12) Patent Application Publication
(10) Pub. No.: US 2009/0074103 A1
(43) Pub. Date: Mar. 19, 2009

(54) RATE MATCHING TO MAINTAIN CODE BLOCK RESOURCE ELEMENT BOUNDARIES

(75) Inventors: Badri N. Varadarajan, Dallas, TX (US); Eko N. Onggosanusi, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/209,100

(22) Filed: Sep. 11, 2008

Related U.S. Application Data
(60) Provisional application No. 60/972,611, filed on Sep. 14, 2007.
(60) Provisional application No. 60/975,418, filed on Sep. 26, 2007.

(51) Int. Cl. H04L 27/00; H04L 27/06

(52) U.S. Cl. 375/295; 375/341

(57) ABSTRACT

Embodiments of the present disclosure provide a transmitter, a receiver and methods of operating a transmitter and a receiver. In one embodiment, the transmitter is for use with multiple transmit antennas and includes an encoding unit configured to segment input bits into one or more code blocks. The transmitter also includes a rate matching unit configured to generate a stream of transmit bits from the one or more code blocks, wherein a group of transmit bits allocated to one resource element originates from only one of the one or more code blocks. The transmitter further includes a mapping unit configured to provide modulated symbols from the stream of transmit bits on a number of spatial transmission layers for one or more resource elements. The transmitter still further includes a transmit unit configured to transmit the modulated symbols employing the multiple transmit antennas.

### CROSS-REFERENCE TO PROVISIONAL APPLICATIONS

This application claims the benefit of U.S. Provisional Application No. 60/972611 entitled “Rate Matching To Maintain Tone Boundaries” to Badri N. Varadarajan and Eko N. Onggosanusi filed on Sep. 14, 2007, which is incorporated herein by reference in its entirety.

This application also claims the benefit of U.S. Provisional Application No. 60/975418 entitled “Rate Matching To Maintain Tone Boundaries” to Badri N. Varadarajan and Eko N. Onggosanusi filed on Sep. 26, 2007, which is incorporated herein by reference in its entirety.

### TECHNICAL FIELD

The present disclosure is directed, in general, to a communication system and, more specifically, to transmitters, receivers and methods of operating transmitters and receivers.

### BACKGROUND

In a cellular network, such as one employing orthogonal frequency division multiple access (OFDMA), each cell employs a base station that communicates with user equipment, such as a cell phone, a laptop, or a PDA, that is actively located within its cell. Typically, the downlink transmission resources are shared among multiple user equipments, wherein each user equipment is scheduled using time-frequency resources. Further, each scheduled user equipment may receive data using differing modulation and coding schemes as well as transmitted code blocks that typically do not align transmission symbols for each user equipment. Although current transmission schemes provide reliable operation, improvements in the transmission processes would prove beneficial in the art.

### SUMMARY OF THE INVENTION

Embodiments of the present disclosure provide a transmitter, a receiver and methods of operating a transmitter and a receiver. In one embodiment, the transmitter is for use with multiple transmit antennas and includes an encoding unit configured to segment input bits into one or more code blocks and provide coded bits for each code block. The transmitter also includes a rate matching unit configured to generate a stream of transmit bits from the one or more code blocks, wherein a group of transmit bits allocated to one resource element originates from only one of the one or more code blocks. The transmitter further includes a mapping unit configured to provide modulated symbols from the stream of transmit bits on a number of spatial transmission layers for one or more resource elements. The transmitter still further includes a transmit unit configured to transmit the modulated symbols employing the multiple transmit antennas.

In another embodiment, the transmitter is for use with multiple transmit antennas and includes an encoding unit configured to segment input bits into one or more code blocks and provide coded bits for each code block. The transmitter also includes a rate matching unit configured to generate a stream of transmit bits from the one or more code blocks, wherein each code block contributes a number of transmit bits equal to a multiple of a product of a layer matching factor and a number of bits per symbol. The transmitter further includes a mapping unit configured to provide modulated symbols from the stream of transmit bits on a number of spatial transmission layers for one or more resource elements. The transmitter still further includes a transmit unit configured to transmit the modulated symbols employing the multiple transmit antennas.

In yet another embodiment, the receiver includes a receiving and demodulating unit configured to receive and demodulate modulated symbols on one or more resource elements into a stream of received bit likelihoods corresponding to a number of spatial transmission layers on each resource element. The receiver also includes a rate de-matching unit configured to generate one or more code blocks of bit likelihoods from the stream of received bit likelihoods, wherein a group of the received bit likelihoods originating from one resource element is allocated to only one of the one or more code blocks. The receiver further includes a decoding unit configured to decode and de-segment the one or more code blocks into data bits.

In yet another embodiment, the receiver includes a receiving and demodulating unit configured to receive and demodulate modulated symbols on one or more resource elements into a stream of received bit likelihoods corresponding to a number of spatial transmission layers on each resource element. The receiver also includes a rate de-matching unit configured to generate one or more code blocks of bit likelihoods from the stream of received bit likelihoods, wherein each code block is allocated a number of bit likelihoods equal to a multiple of a product of a layer-matching factor and a number of bits per modulated symbol. The receiver further includes a decoding unit configured to decode and de-segment the one or more code blocks into data bits.

In another aspect, the method of operating a transmitter is for use with multiple transmit antennas and includes segmenting input bits into one or more code blocks and providing coded bits for each code block. The method also includes generating a stream of transmit bits from the one or more code blocks, wherein a group of transmit bits allocated to one resource element originates from only one of the one or more code blocks. The method further includes providing modulated symbols from the stream of transmit bits on a number of spatial transmission layers for one or more resource elements and transmitting the modulated symbols employing the multiple transmit antennas.

In yet another aspect, the method of operating a transmitter is for use with multiple transmit antennas and includes segmenting input bits into one or more code blocks and providing coded bits for each code block. The method also includes generating a stream of transmit bits from the one or more code blocks, wherein each code block contributes a number of transmit bits equal to a multiple of a product of a layer matching factor and a number of bits per symbol. The method further includes providing modulated symbols from the stream of transmit bits on a number of spatial transmission layers for one or more resource elements and transmitting the modulated symbols employing the multiple transmit antennas.

In yet another aspect, the method of operating a receiver includes receiving and demodulating modulated symbols on one or more resource elements into a stream of received bit likelihoods corresponding to a number of spatial transmission layers on each resource element. The method also includes generating one or more code blocks of bit likelihoods from the stream of received bit likelihoods, wherein a group of the received bit likelihoods originating from one resource element is allocated to only one of the one or more code blocks. The method further includes decoding and de-segmenting the one or more code blocks into data bits.

In a further aspect, the method of operating a receiver includes receiving and demodulating modulated symbols on one or more resource elements into a stream of received bit likelihoods corresponding to a number of spatial transmission layers on each resource element. The method also includes generating one or more code blocks of bit likelihoods from the stream of received bit likelihoods, wherein each code block is allocated a number of bit likelihoods equal to a multiple of a product of a layer-matching factor and a number of bits per modulated symbol. The method further includes decoding and de-segmenting the one or more code blocks into data bits.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates a diagram of a transmitter constructed according to the principles of the present disclosure;

FIG. 2 illustrates a diagram of a receiver constructed according to principles of the present disclosure;

FIG. 3 illustrates a flow diagram of a method of operating a transmitter carried out according to the principles of the present disclosure.

FIG. 4 illustrates a flow diagram of another method of operating a transmitter carried out according to the principles of the present disclosure;

FIG. 5 illustrates a flow diagram of a method of operating a receiver carried out according to the principles of the present disclosure; and

FIG. 6 illustrates a flow diagram of another method of operating a receiver 600 carried out according to the principles of the present disclosure.

### DETAILED DESCRIPTION

Many packet-based communication systems perform rate-matching at a transmitter. That is, they ensure that an arbitrary number of input bits is processed to fit into a given number of transmit resources. Currently, in a 3GPP LTE system for example, rate-matching may proceed as follows.

First, the input bits are segmented into one or more code blocks. Typically, this segmentation is done in such a way that no code block exceeds a certain predetermined maximum size. Second, bits on each code block are encoded and interleaved to obtain code block output bits. The third step is rate-matching, where some output bits are selected from each of these code blocks so that the total number of output bits equals the available number of bits that can be transmitted. Typically, this number is determined by a number of resource elements (such as tones or equivalent data-carrying units per unit time) multiplied by the data carrying capacity of each resource element, which is discussed below.

The serial stream of output bits is then mapped into QAM symbols, with Qₘ bits required to obtain each QAM symbol. The modulated symbols are split into N_{L} layers by a serial-to-parallel converter. Each vector of N_{L} modulated symbols is mixed with modulated symbols from other transport blocks (if any), and mapped onto a resource element (such as a tone). Thus, the data-carrying capacity of each resource element, mentioned above equals Qₘ*L. If the number of tones is T, the total number of output bits generated by the rate-matching unit becomes G=T*L*Qₘ. To give numerical examples, the QAM dimension Qₘ used in 3GPP LTE is two, four or six, and the number of layers L equals one, two or four.

This disclosure focuses on the rate-matching operation and specifically the relation between coded bits from different code blocks and the corresponding resource elements onto which they are mapped. In the prior art, currently, the number of bits from each code block may be obtained as follows.

$$Set {G}^{′} = \frac{G}{{Q}_{m}}$$

Set y=G′ mod C, where C is the number of code blocks.

For r = 0, 1, . . . , C − 1

$if r \leq C - γ - 1 set {E}_{r} = {Q}_{m} * ⌊ \frac{{G}^{′}}{C} ⌋$
$else set {E}_{r} = {Q}_{m} * ⌈ \frac{{G}^{′}}{C} ⌉$
end if

end

The above relationship ensures that each code block produces an integer number of modulated symbols. However, it does not ensure that each code block produces bits for an integer number of tones, because Eᵣ may not be divisible by the product Qₘ *L, which is the number of bits per tone. In such cases, there are some resource elements which contain coded bits from more than one code block.

Specifically, consider an example where T=98, L=2 and C=3. (or any case where C does not divide T for L>1). Note that the number of modulated symbols produced in this example by the three code blocks will be {65,65,66}. For the first two code blocks, the number of modulated symbols is not divisible by the number of symbols per tone. Thus, there will be one tone which has one modulated symbol from the first code block and the other modulated symbol from the second code block.

It is desirable to ensure that rate-matching preserves resource element boundaries. That is, all of the bits needed to construct the transmit signal for a given resource element come from only one of the code blocks. One reason to require this condition is that some receivers employ a successive interference cancellation (SIC) decoder. These decoders reconstruct the transmit signal from a forward error correcting (FEC) decoder output, which is available on a code block basis. This output is used for cancellation of interference associated with other spatial transmission streams.

Therefore, if a resource element requires bits from different code blocks, the transmit signal on that resource element cannot be constructed until all code blocks have been decoded, which unnecessarily increases the latency of SIC decoding, for example. Embodiments of the present disclosure ensure that code block boundaries are aligned with resource element boundaries.

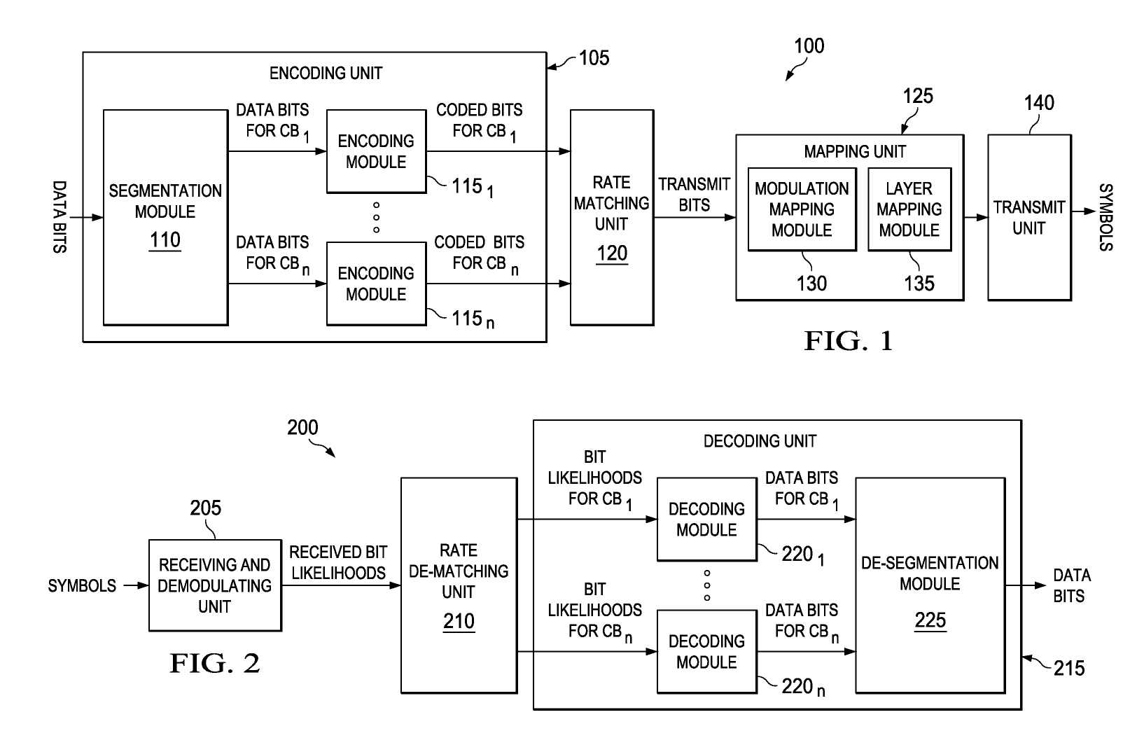

FIG. 1 illustrates a diagram of a transmitter 100 constructed according to the principles of the present disclosure. The transmitter 100 may correspond to a base station transmitter in a cellular network, wherein the cellular network may be part of an OFDMA communication system. The transmitter 100 is for use with multiple transmit antennas and includes an encoding unit 105, a rate matching unit 120, a mapping unit 125 and a transmit unit 140. The encoding unit 105 includes a segmentation module 110 and a collection of encoding modules 115₁-115n. The mapping unit 125 includes a modulation mapping module 130 and a layer mapping module 135.

The encoding unit 105 encodes input data bits into one or more code blocks. In the illustrated embodiment, the segmentation module 110 accepts a stream of input data bits and segments them into a collection of code blocks CB₁-CBn. Each of the collection of encoding modules 115₁-115n encodes the input data bits in its respective code block to provide encoded bits in the collection of code blocks CB₁-CBn, which serve as inputs to the rate matching unit 120.

The rate matching unit 120 generates a stream of transmit bits from the collection of code blocks CB₁-CBn. In one embodiment, a group of transmit bits allocated to one resource element originates from only one of the collection of code blocks CB₁-CBn. In another embodiment, each code block contributes a number of transmit bits equal to a multiple of a product of a layer matching factor and a number of bits per symbol. The mapping unit 125 employs the modulation mapping module 130 to provide modulated symbols from the stream of transmit bits on a number of spatial transmission layers for one or more resource elements employing the layer mapping module 135. The transmit unit 140 transmits the modulated symbols employing the multiple transmit antennas. In other embodiments of this disclosure, the transmit unit 140 may also combine modulated symbols from other transport blocks.

FIG. 2 illustrates a diagram of a receiver 200 constructed according to principles of the present disclosure. The receiver 200 corresponds to user equipment operating in a cellular network such as an OFDMA communication system. The receiver 100 includes a receiving and demodulating unit 205, a rate de-matching unit 210 and a decoding unit 215. The decoding unit 215 includes a collection of decoding modules 220₁-220n and a de-segmentation module 225.

The receiving and demodulation unit 205 receives and demodulates modulated symbols on one or more resource elements into a stream of received bit likelihoods corresponding to a number of spatial transmission layers on each resource element. The rate de-matching unit 210 generates one or more code blocks CB₁-CBn of bit likelihoods from the stream of received bit likelihoods. In one embodiment, a group of the received bit likelihoods originating from one resource element is allocated to only one of the one or more code blocks CB₁-CBn. In another embodiment, each code block is allocated a number of bit likelihoods equal to a multiple of a product of a layer matching factor and a number of bits per modulated symbol.

The decoding unit 215 employs the collection of decoding modules 220₁-220n to decode the one or more code blocks CB₁-CBn from encoded bits into data bits. The de-segmentation module 225 de-segments the resulting data bits of the one or more code blocks CB₁-CBn and combines them into a stream of data bits.

The embodiments of FIGS. 1 and 2 provide rate matching and rate de-matching that ensure code block boundaries are aligned with resource element boundaries, as illustrated below.

```
Set G'=G/(N_{L}·Qₘ)
Set γ=G'modC, where C is the number of code blocks.
For r=0,1,...,C−1
  if r≦C−γ−1
    setE=N_{L}·Qₘ·♯G'/C♭
  else
    setE=N_{L}·Qₘ·⊕G'/Cβ
  end if
end
```

It may be seen that the number of output bits per code block is guaranteed to be a multiple of the product N_{L}*Qₘ. In one embodiment, the value of N_{L} equals the number of layers L. Thus, in the numerical example considered above (T=98, N_{L}=L=2 and C=3), it is easy to see that the above procedure yields {64,66,66} as the number of modulated symbols produced from each code block.

Other variations of this theme are also possible. For example, the layer matching factor N_{L} above may be different from the employed number of spatial transmission layers. For instance, it may be any multiple of the number of transmission layers. One exemplary method is to set the layer matching factor N_{L} equal to the number of transmit antennas, since this is the maximum number of transmission layers. Another example is to set the layer matching factor N_{L} to be some number which is always divisible by the number of spatial transmission layers. For example, a layer matching factor N_{L} equal to four may be used even if there is only one or two transmit antennas.

Another variation is to ensure that each equalizer block contains information from the same code block. This becomes important when space-time or space-frequency coding is used across multiple modulated symbol vectors. In this case, the number of layers equals the number of transmit antennas. However, any given resource element only contains two modulated symbols. Thus, in this case, it is sufficient to choose N_{L}=2 even though the number of layers is L=4.

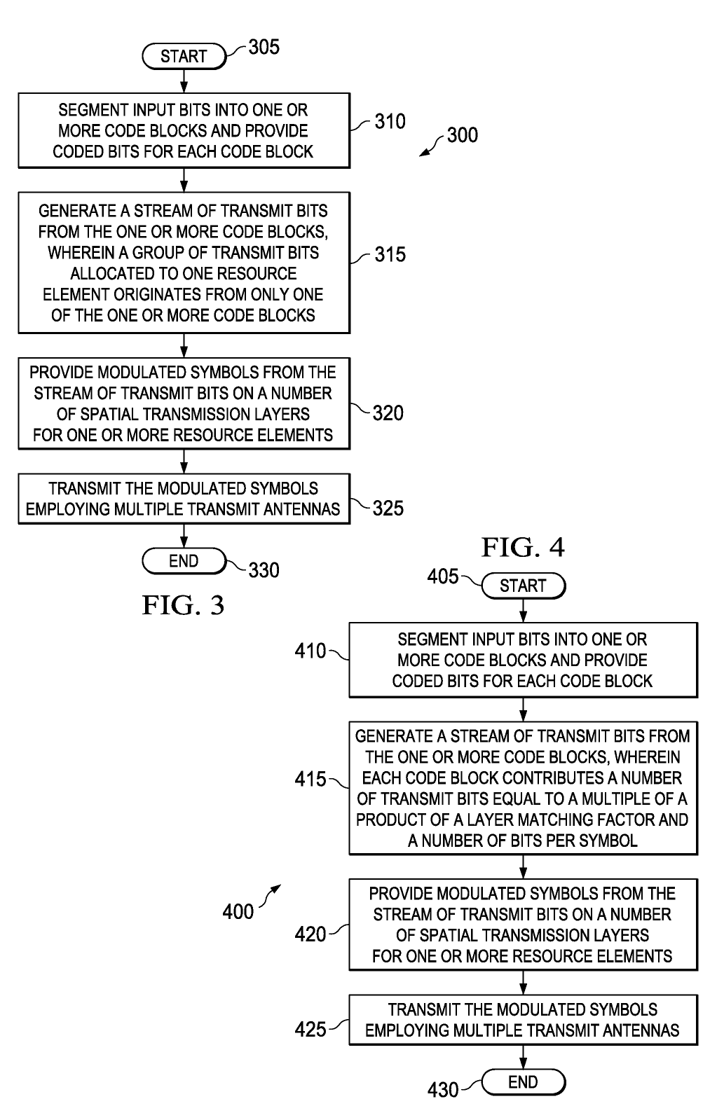

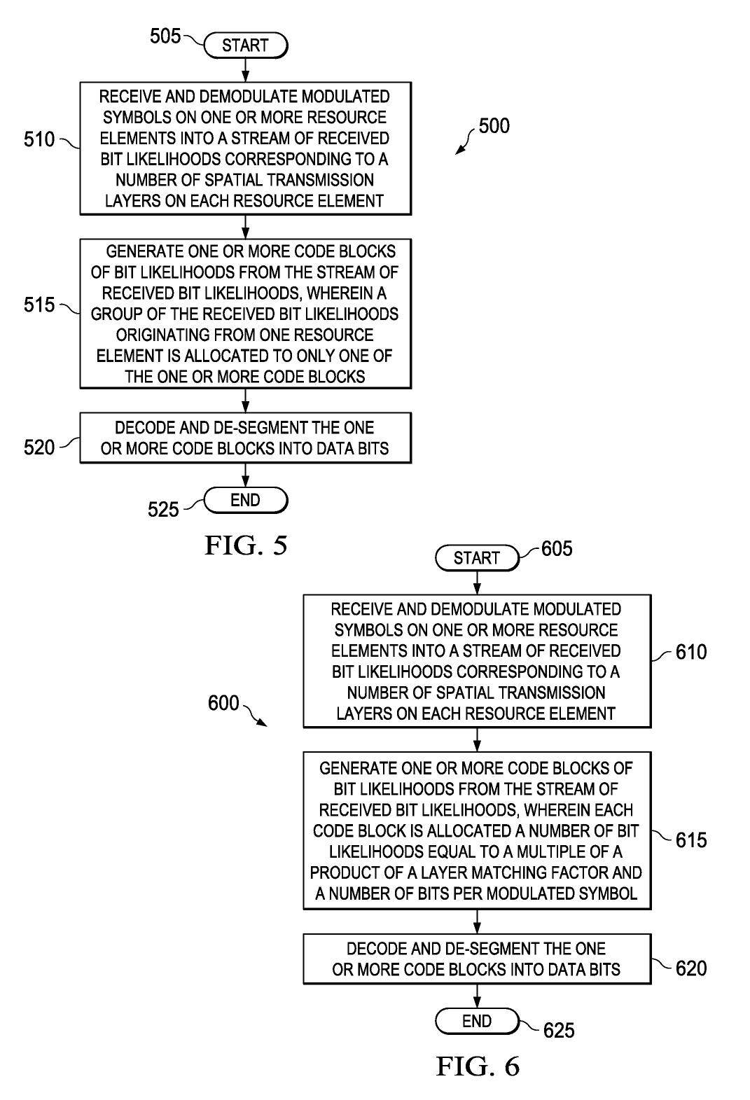

In summary, one set of embodiments of the rate matching and rate de-matching schemes presented ensure that each resource element (such as a tone) only contains bits from the same code block. This employs use of the number of modulated symbols carried on each resource element for a given transport block. In particular, in the spatial multiplexing mode of 3GPP LTE, the number of modulated symbols is equal to the number of spatial transmission layers per transport block, which may be one or two. These embodiments are further discussed with respect to FIGS. 3 and 5.

Another set of embodiments of the rate matching and rate de-matching schemes presented ensure that the number of transmit bits from each code block is a multiple of a basic quantum, which is given by a product of a layer-matching factor and the number of bits per modulated symbol. The layer matching factor may equal to, or be less than, the number of transmission layers. For example, in the transmit diversity mode of 3GPP LTE, the layer matching factor is two, for both two and four spatial transmission layers. These embodiments are further discussed with respect to FIGS. 4 and 6.

FIG. 3 illustrates a flow diagram of a method of operating a transmitter 300 carried out according to the principles of the present disclosure. The method 300 may be employed by a base station transmitter having multiple transmit antennas, such as the one described with respect to FIG. 1, and starts in a step 305. Then, in a step 310, input bits are segmented into one or more code blocks and coded bits are provided for each code block. A stream of transmit bits is generated from the one or more code blocks, wherein a group of transmit bits allocated to one resource element originates from only one of the one or more code blocks, in a step 315.

In one embodiment, the group of transmit bits allocated to the one resource element consists of contiguous bits in the stream of transmit bits. Additionally, the group of transmit bits allocated to the one resource element corresponds to two, four or six bits for each modulated symbol.

Modulated symbols are provided from the group of transmit bits allocated to the one resource element on a number of spatial transmission layers for one or more resource elements, in a step 320. The modulated symbols are transmitted employing the multiple transmit antennas in a step 325, and the method 300 ends in a step 330.

FIG. 4 illustrates a flow diagram of another method of operating a transmitter 400 carried out according to the principles of the present disclosure. The method 400 may also be employed by a base station transmitter having multiple transmit antennas, such as the one described with respect to FIG. 1, and starts in a step 405.

Then, in a step 410, input bits are segmented into one or more code blocks and coded bits are provided for each code block. A stream of transmit bits is generated from the one or more code blocks, wherein each code block contributes a number of transmit bits equal to a multiple of a product of a layer matching factor and a number of bits per symbol, in a step 415.

In one embodiment, the layer matching factor may be equal to the number of spatial transmission layers. Alternatively, the layer matching factor may be a multiple of the number of spatial transmission layers. Additionally, the layer matching factor may be equal to two while the number of spatial transmission layers equals four.

Modulated symbols are provided from the stream of transmit bits on a number of spatial transmission layers for one or more resource elements, in a step 420. The modulated symbols are transmitted employing the multiple transmit antennas in a step 425, and the method 400 ends in a step 430.

FIG. 5 illustrates a flow diagram of a method of operating a receiver 500 carried out according to the principles of the present disclosure. The method 500 may be employed by a user equipment receiver, such as the one described with respect to FIG. 2, and starts in a step 505. Then, in a step 510, modulated symbols on one or more resource elements are received and demodulated into a stream of received bit likelihoods corresponding to a number of spatial transmission layers on each resource element.

One or more code blocks of bit likelihoods is generated from the stream of received bit likelihoods in a step 515, wherein a group of the received bit likelihoods originating from one resource element is allocated to only one of the one or more code blocks. The group of received bit likelihoods originating from the one resource element consists of contiguous bit likelihoods in the stream of received bit likelihoods. Additionally, the group of received bit likelihoods originating from the one resource element corresponds to two, four or six bits for each modulated symbol. The one or more code blocks are decoded and de-segmented into data bits in a step 520, and the method 500 ends in a step 525.

FIG. 6 illustrates a flow diagram of another method of operating a receiver 600 carried out according to the principles of the present disclosure. The method 600 may also be employed by a user equipment receiver, such as the one described with respect to FIG. 2, and starts in a step 605. Then, in a step 610, modulated symbols on one or more resource elements are received and demodulated into a stream of received bit likelihoods corresponding to a number of spatial transmission layers on each resource element.

One or more code blocks of bit likelihoods is generated from the stream of received bit likelihoods in a step 615, wherein each code block is allocated a number of bit likelihoods equal to a multiple of a product of a layer matching factor and a number of bits per modulated symbol.

The layer matching factor may be equal to the number of spatial transmission layers. Alternately, the layer matching factor may be a multiple of the number of spatial transmission layers. Additionally, the layer matching factor may equal two while the number of spatial transmission layers equals four. The one or more code blocks are decoded and de-segmented into data bits in a step 620, and the method 600 ends in a step 625.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which the disclosure relates will appreciate that other and further additions, deletions, substitutions and modifications may be made to the described example embodiments without departing from the disclosure.

What is claimed is:

1. A transmitter for use with multiple transmit antennas, comprising:
an encoding unit configured to segment input bits into one or more code blocks and provide coded bits for each code block;
a rate matching unit configured to generate a stream of transmit bits from the one or more code blocks, wherein a group of transmit bits allocated to one resource element originates from only one of the one or more code blocks;
a mapping unit configured to provide modulated symbols from the stream of transmit bits on a number of spatial transmission layers for one or more resource elements; and
a transmit unit configured to transmit the modulated symbols employing the multiple transmit antennas.

2. The transmitter as recited in claim 1 wherein the group of transmit bits allocated to each resource element, consists of contiguous bits in the stream of transmit bits.

3. The transmitter as recited in claim 1 wherein the group of transmit bits allocated to each resource element corresponds to two, four or six bits for each modulated symbol.

4. A transmitter for use with multiple transmit antennas, comprising:
an encoding unit configured to segment input bits into one or more code blocks and provide coded bits for each code block;
a rate matching unit configured to generate a stream of transmit bits from the one or more code blocks, wherein each code block contributes a number of transmit bits equal to a multiple of a product of a layer matching factor and a number of bits per symbol;
a mapping unit configured to provide modulated symbols from the stream of transmit bits on a number of spatial transmission layers for one or more resource elements; and
a transmit unit configured to transmit the modulated symbols employing the multiple transmit antennas.

5. The transmitter as recited in claim 4 wherein the layer matching factor is equal to the number of spatial transmission layers.

6. The transmitter as recited in claim 4 wherein the layer matching factor is a multiple of the number of spatial transmission layers.

7. The transmitter as recited in claim 4 wherein the layer matching factor equals two and the number of spatial transmission layers equals four.

8. A receiver, comprising:
a receiving and demodulating unit configured to receive and demodulate modulated symbols on one or more resource elements into a stream of received bit likelihoods corresponding to a number of spatial transmission layers on each resource element;
a rate de-matching unit configured to generate one or more code blocks of bit likelihoods from the stream of received bit likelihoods, wherein a group of the received bit likelihoods originating from one resource element is allocated to only one of the one or more code blocks; and
a decoding unit configured to decode and de-segment the one or more code blocks into data bits.

9. The receiver as recited in claim 8 wherein the group of received bit likelihoods originating from the one resource element consists of contiguous bit likelihoods in the stream of received bit likelihoods.

10. The receiver as recited in claim 8 wherein the group of received bit likelihoods originating from the one resource element corresponds to two, four or six bits for each modulated symbol.

11. A receiver, comprising:
a receiving and demodulating unit configured to receive and demodulate modulated symbols on one or more resource elements into a stream of received bit likelihoods corresponding to a number of spatial transmission layers on each resource element;
a rate de-matching unit configured to generate one or more code blocks of bit likelihoods from the stream of received bit likelihoods, wherein each code block is allocated a number of bit likelihoods equal to a multiple of a product of a layer matching factor and a number of bits per modulated symbol; and
a decoding unit configured to decode and de-segment the one or more code blocks into data bits.

12. The receiver as recited in claim 11 wherein the layer matching factor is equal to the number of spatial transmission layers.

13. The receiver as recited in claim 11 wherein the layer matching factor is a multiple of the number of spatial transmission layers.

14. The receiver as recited in claim 11 wherein the layer matching factor equals two and the number of spatial transmission layers equals four.

15. A method of operating a transmitter for use with multiple transmit antennas, comprising:
segmenting input bits into one or more code blocks and providing coded bits for each code block;
generating a stream of transmit bits from the one or more code blocks, wherein a group of transmit bits allocated to one resource element originates from only one of the one or more code blocks;
providing modulated symbols from the stream of transmit bits on a number of spatial transmission layers for one or more resource elements; and
transmitting the modulated symbols employing the multiple transmit antennas.

16. The method as recited in claim 15 wherein the group of transmit bits allocated to each resource element consists of contiguous bits in the stream of transmit bits.

17. The method as recited in claim 15 wherein the group of transmit bits allocated to each resource element corresponds to two, four or six bits for each modulated symbol.

18. A method of operating a transmitter for use with multiple transmit antennas, comprising:
segmenting input bits into one or more code blocks and providing coded bits for each code block;
generating a stream of transmit bits from the one or more code blocks, wherein each code block contributes a number of transmit bits equal to a multiple of a product of a layer matching factor and a number of bits per symbol;
providing modulated symbols from the stream of transmit bits on a number of spatial transmission layers for one or more resource elements; and
transmitting the modulated symbols employing the multiple transmit antennas.

19. The method as recited in claim 18 wherein the layer matching factor is equal to the number of spatial transmission layers.

20. The method as recited in claim 18 wherein the layer matching factor is a multiple of the number of spatial transmission layers.

21. The method as recited in claim 18 wherein the layer matching factor equals two and the number of spatial transmission layers equals four.

22. A method of operating a receiver, comprising:
receiving and demodulating modulated symbols on one or more resource elements into a stream of received bit likelihoods corresponding to a number of spatial transmission layers on each resource element;
generating one or more code blocks of bit likelihoods from the stream of received bit likelihoods, wherein a group of the received bit likelihoods originating from one resource element is allocated to only one of the one or more code blocks; and
decoding and de-segmenting the one or more code blocks into data bits.

23. The method as recited in claim 22 wherein the group of received bit likelihoods originating from the one resource element consists of contiguous bit likelihoods in the stream of received bit likelihoods.

24. The method as recited in claim 22 wherein the group of received bit likelihoods originating from the one resource element corresponds to two, four or six bits for each modulated symbol.

25. A method of operating a receiver, comprising:
receiving and demodulating modulated symbols on one or more resource elements into a stream of received bit likelihoods corresponding to a number of spatial transmission layers on each resource element;
generating one or more code blocks of bit likelihoods from the stream of received bit likelihoods, wherein each code block is allocated a number of bit likelihoods equal to a multiple of a product of a layer-matching factor and a number of bits per modulated symbol; and
decoding and de-segmenting the one or more code blocks into data bits.

26. The method as recited in claim 25 wherein the layer matching factor is equal to the number of spatial transmission layers.

27. The receiver as recited in claim 25 wherein the layer matching factor is a multiple of the number of spatial transmission layers.

28. The receiver as recited in claim 25 wherein the layer matching factor equals two and the number of spatial transmission layers equals four.
